(19) United States
(12) Patent Application Publication
(10) Pub. No.: US 2025/0260548 A1
(43) Pub. Date: Aug. 14, 2025

(54) METHODS AND SIGNALING FOR PREDICTION-BASED BEAMFORMING

(71) Applicant: APPLE INC., Cupertino, CA (US)

(72) Inventors: Ankit Bhamri, Munich (DE); Oghenekome Oteri, San Diego, CA (US); Wei Zeng, Saratoga, CA (US); Huaning Niu, San Jose, CA (US); Weidong Yang, San Digeo, CA (US); Dawei Zhang, Saratoga, CA (US); Haitong Sun, Cupertino, CA (US); Chunxuan Ye, San Diego, CA (US)

(21) Appl. No.: 19/043,872

(22) Filed: Feb. 3, 2025

Related U.S. Application Data
(60) Provisional application No. 63/551,241, filed on Feb. 8, 2024.

(51) Int. Cl. H04L 5/00; H04W 72/044

(52) U.S. Cl. CPC H04L 5/0094; H04L 5/0053; H04W 72/046

(57) ABSTRACT

Systems, methods, and signaling for prediction-based beamforming are discussed herein. For example, a user equipment (UE) may receive, from a base station, a configuration message indicating one or more transmission configuration indicator (TCI) states and one or more time durations corresponding to the one or more TCI states. The UE may further progressively switch between the one or more TCI states, wherein the one or more time durations indicate an amount of time for the UE to remain in the one or more TCI states. The UE may further perform beamforming according to a current TCI state as switching between the one more TCI states occurs. In some cases, the configuration message comprises an index value that indicates the TCI states and the time durations. In some examples, the TCI states are joint TCI states for uplink (UL) and downlink (DL) transmission.

### TECHNICAL FIELD

This application relates generally to wireless communication systems, including beamforming related configuration, signaling, and reporting.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates an example of wide beam dwelling time for beam updating frequency, in accordance with some embodiments.

FIG. 1B illustrates an example of narrow beam dwelling time for beam updating frequency, in accordance with some embodiments.

FIG. 2 illustrates an example of enhanced medium access control control element (MAC CE) activation of TCI, according to embodiments herein.

FIG. 3 illustrates examples of enhanced MAC CE activation of TCI, according to embodiments herein.

FIG. 4 illustrates an example of separate TCIs with a unified TCI framework, according to embodiments herein.

FIG. 5 illustrates a method for a UE, according to embodiments herein.

FIG. 6 illustrates a method for a base station, according to embodiments herein.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communication systems, the general trend for the evolution of beam management has been to reduce the overhead and latency involved with each step of the beam-management procedure. For example, for beam update frequency, a beam dwelling time can become shorter for FR2 (or for FR3) and for sub-THz considering larger antenna arrays that can enable narrower beams for increased link budget. For example, for a UE traversing the same distance with the same mobility, but with narrower beams, the beam dwelling time is reduced and consequently more frequent beam updates may be needed.

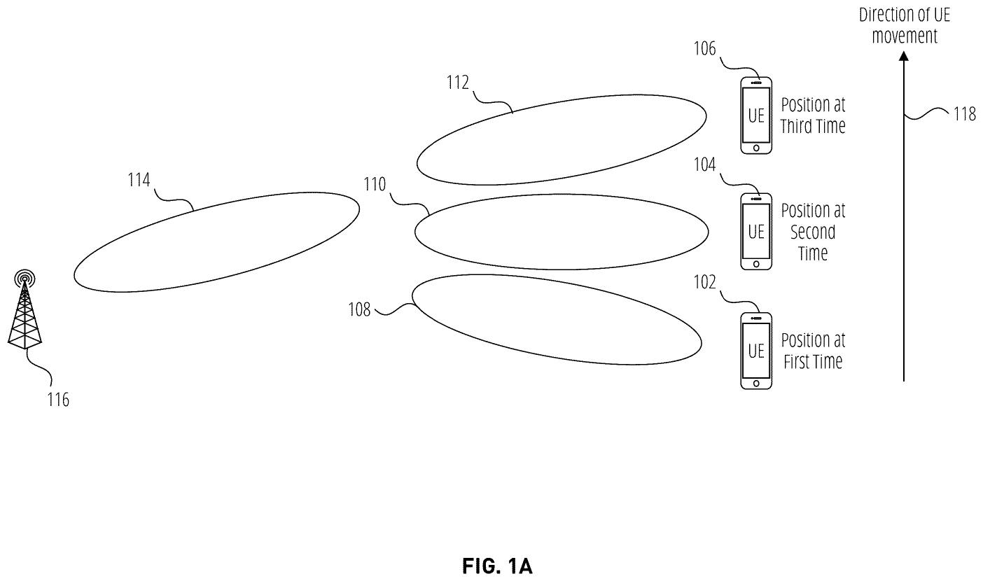

FIG. 1A illustrates an example of wide beam dwelling time for beam updating frequency in accordance with some embodiments. For a wide beam dwelling time for beam updating, a base station 116 may transmit a beam 114 with a wider beam dwelling time less often as the UE moves across a certain distance 118 than if a narrower beam is used.

For example, the base station 116 may transmit a first wide dwelling time beam 108 when the UE is at a first position at a first time 102. The base station 116 may transmit a second wide dwelling time beam 110 when the UE is at a second position at a second time 104. The base station 116 may transmit a third wide dwelling time beam 112 when the UE is at a third position at a third time 106.

FIG. 1B illustrates an example of narrow beam dwelling time for beam updating frequency, in accordance with some embodiments. For a narrow beam dwelling time for beam updating, a base station 116 may transmit a beam 114 with a narrower beam dwelling time more often as the UE moves across a certain distance 118 than would be done with a wider beam.

For example, the base station 116 may transmit a first narrow dwelling time beam 120 when the UE is at a first position at a first time 130. The base station 116 may transmit a second narrow dwelling time beam 122 when the UE is at a second position at a second time 132. The base station 116 may transmit a third narrow dwelling time beam 124 when the UE is at a third position at a third time 134. The base station 116 may transmit a fourth narrow dwelling time beam 126 when the UE is at a fourth position at a fourth time 136. The base station 116 may transmit a fifth narrow dwelling time beam 128 when the UE is at a fifth position at a fifth time 138.

Note that the base station 116 illustrated in FIG. 1A transmits three wide beams as the UE moves across the certain distance 118 whereas the base station 116 illustrated in FIG. 1B transmitted five narrow beams as the UE moves across the certain distance 118. As a result, the beam dwelling time may be shorter and the beams may be transmitted at a higher frequency (e.g., more often) when the narrow beams are used.

Based on the current TCI framework, for a larger number of narrower beams and more frequent switching between narrower beams, in some instances, the pool size of activated TCI states may be increased, as illustrated in FIG. 1B, however, an overhead issue may be encountered as there may be an increased downlink control information (DCI) budget for TCI indication. In some other instances, the same pool size of activated TCI states may be kept the same, however, there may be a latency issue as the activated TCI pools may be frequently updated. Note that three milliseconds (ms) of latency may be needed for every medium access control (MAC) enabled pool update.

In various mechanisms, typically, whenever a beam update is needed, the beam update is not random or erratic. The update is transmitted to one of the neighboring beams and can be considered as a pseudo-prediction. Further, it may be beneficial to use artificial intelligence/machine learning (AI/ML) models for beam-management as beam switching may be more accurately predicted. Embodiments discussed herein consider a beamforming related configuration, signaling and reporting enhancements based on the assumption of beam prediction at the network and/or UE side.

Some embodiments discussed herein include details on enhanced TCI configuration, activation, and indication for a unified TCI framework. Both joint and separate uplink (UL) TCI and downlink (DL) TCI are considered and both single transmit receive point (TRP) and multiple-TRP (multi-TRP) scenarios are considered. Additionally, some embodiments herein discuss enhanced reporting for UE based beam prediction.

Embodiments herein may reduce both overhead and latency requirements and may alleviate the need to frequently indicate TCIs in scheduling or non-scheduling DCI when using the enhanced TCI configurations discussed herein. It should be understood that while embodiments and examples herein refer to TCI states at the slot level for transmission, embodiments and examples herein may be applied at the symbol level for transmission.

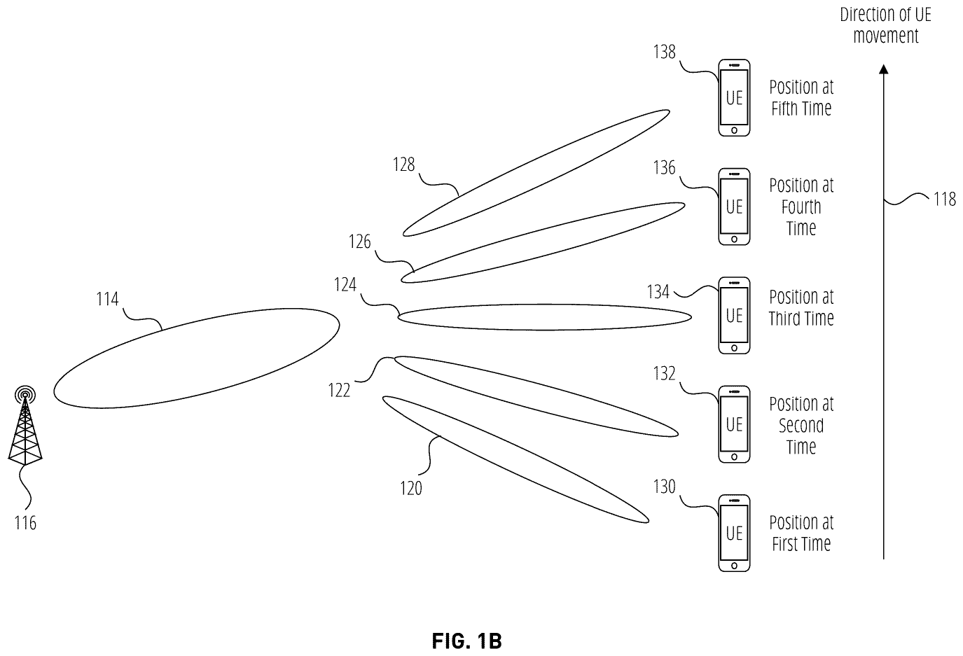

FIG. 2 illustrates an example of enhanced MAC CE activation of TCI, according to embodiments herein. As shown, one or more index values may be configured to be associated with one or more TCI states for a certain time duration. The base station 202 may send the UE 204 the index value (e.g., via a DCI) to configure the UE 204 to use the TCI states associated with the index value for the duration of time associated with the index value.

In some embodiments, MAC CE activation for TCI states may activate multiple TCI states for at least one time duration per index, wherein the DCI may indicate one index from the activated list. Accordingly, based on the multiple TCI states and the time duration, mapping of TCI states and corresponding application time may be determined. An example of a MAC CE activation for TCI states activating multiple TCI states is now discussed.

Various TCI state indexes corresponding to TCI states may be predicted, using for example an AI/ML model, at either the base station 202 or the UE 204, based on the location of the UE 204 and the movement of the UE 204. For example, if a UE 204 is to move north 208 it may be predicted that the TCI states corresponding to TCI index 0 are the most optimal to use. If the UE 204 is to move south 210 it may be predicted that the TCI states corresponding to TCI index 2 are the most optimal to use. If the UE 204 is to move east 206 it may be predicted that the TCI states corresponding to TCI index 1 are the most optimal to use. The example illustrated in FIG. 2 contemplates that the UE 204 moves east 206 and that a TCI index 1 is predicted to be most optimal, however note that other examples may contemplate when various other TCI states corresponding to other TCI indexes are predicted to be most optimal.

Then, in a first step, a radio resource control (RRC) configuration of TCI states 212 may be performed. For example, the RRC configuration of TCI states 212 may include TCI State 1, TCI State 2, TCI State 3, and so on up to, e.g., TCI State 128. The base station 202 may send the RRC configuration to the UE 204 to configure the set of TCI states 212.

In a second step, MAC CE activation may be performed. The base station 202 may send the UE 204 a MAC CE to activate lists of one or more of the TCI states 212 configured by the RRC configuration. The MAC CE activates 214 a pool of one or more TCI indices (e.g., eight TCI indices). Each index corresponds to a list of TCI states, and at least one single time association time duration (also referred to herein as “T”). The indicated time duration applies for the beam/TCI switching time in the sequence of associated TCI states.

For example, as illustrated in FIG. 2, the activated pool of TCI indices may include an index 0 with TCI states L, M, and N where each TCI state is to be used for a time duration of two slots. The activated pool of TCI indices may include an index 1 with TCI states L, M, and N where each TCI state is to be used for a time duration of one slot. The activated pool of TCI indices may include an index 2 with TCI states L, M, and N where each TCI state is to be used for a time duration of four slots. The activated pool of TCI indices may include an index 3 with TCI states L, M, and N where each TCI state is to be used for a time duration of two slots. The activated pool of TCI indices may include an index 4 with TCI states L, M, and N where each TCI state is to be used for a time duration of one slot. The activated pool of TCI indices may include an index 5 with TCI states L, M, and N where each TCI state is to be used for a time duration of four slots. The activated pool of TCI indices may include an index 6 with TCI states L, M, and N where each TCI state is to be used for a time duration of two slots. The activated pool of TCI indices may include an index 7 with TCI states L, M, and N where each TCI state is to be used for a time duration of two slots.

In a third step, a DCI indication may be sent to the UE 204 from the base station 202 to indicate which index of the activated pool of TCI indices to use. The DCI may have a TCI field that points to one of the indexes from the MAC CE activated pool of TCI indices. From the indicated index, the UE may apply the first TCI state in the associated TCI sequence according to the time duration corresponding to the indicated index. The UE may then apply the next TCI state in the sequence after time duration “T” corresponding to the index and so on.

For example, as illustrated in FIG. 2, the DCI, transmitted from the base station 202, may indicate 216 index 1 to the UE 204 in a first slot 218. According to the activated pool of TCI indices, TCI states L, M, and N are to each be used for a time duration of one slot each. Thus, the UE may switch to TCI state L 222 for the second slot 220 (one slot in time duration), may switch to TCI state M 226 for the third slot 224 (one slot in time duration) and may switch to TCI state N 230 for the fourth slot 228 (one slot in time duration). In the illustrated embodiment, each of the TCI states (e.g., TCI state L 222, TCI state M 226 and TCI state N 230) are used for beamforming during the slot that the UE is in the TCI state.

Note that the use of the MAC activated pool of indices corresponding to TCI states reduces both overhead and latency requirements and may alleviate the need to frequently indicate TCIs in scheduling or non-scheduling DCI.

Additionally, or alternatively, if a new DCI is received before the expiration of the duration of previously indicated TCI states, then, in some cases, a new indicated list of TCI states may be applied before the expiration of previously indicated TCI states. In some other cases, a new indicated list of TCI states may be applied after the expiration of previously indicated TCI states.

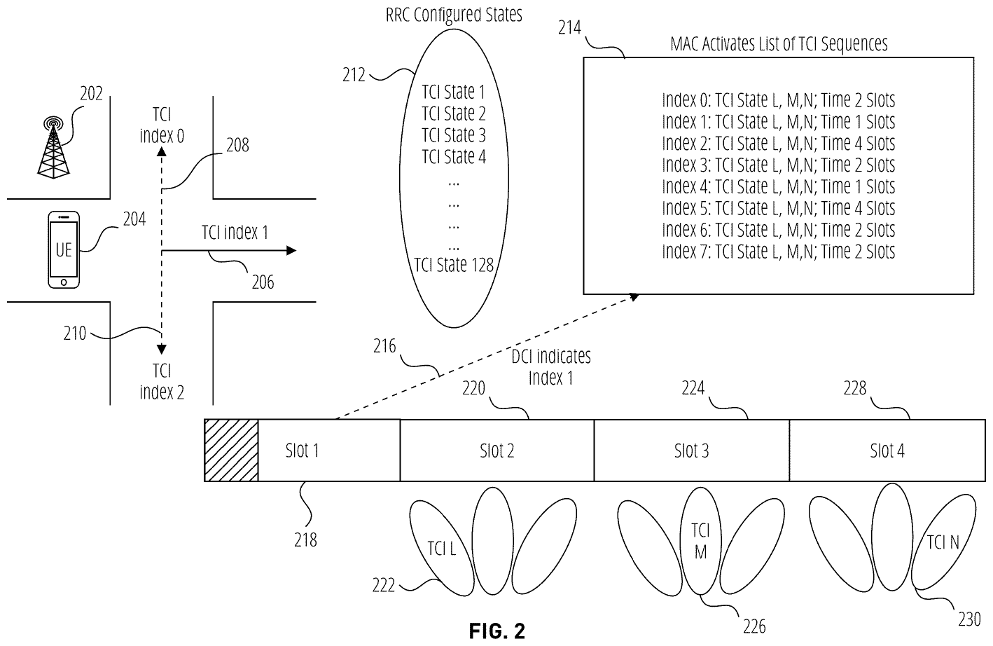

FIG. 3 illustrates examples of enhanced MAC CE activation of TCI, according to embodiments herein.

In some cases, a single time resource associated with each of the MAC CE indices may be used to determine the total time duration of the list of TCI states, where the duration for each of the TCI state is up to UE implementation. In such cases, the network may be able to use the same transmit/receive (Tx/Rx) beam for transmission and/or reception corresponding to the list of TCI states associated with that index (e.g., the index configured by a MAC CE corresponding a list of TCI states and one or more time durations).

For instance, the base station may indicate an index associated with TCI L and TCI M. The index may also be associated with a time duration. The time duration may be the total time duration 318 for the list of TCI states. The UE may transition through the TCI states associated with the index within the total time duration 318.

For example, in a first slot 302 the MAC CE index may indicate to the UE to first switch to TCI state L 306 for the first time duration 314 and to then switch to TCI state M 312 for the second time duration 316. The first time duration 314 may include the second slot 304 and third slot 308 where TCI state L 306 is to be used and the second time duration 316 may include the fourth slot 228 where TCI state M 312 is to be used. Note that the first time duration 314 and the second time duration 316 may be up to UE implementation.

In some other cases, multiple time resources may be associated with each MAC CE index (e.g., the index configured by a MAC CE corresponding a list of TCI states and one or more time durations), where one-to-one mapping between a time resource and the corresponding TCI state within the index may be applied. The same number of time resources may be the same as the number of TCI states within each index. For example, in a first slot 302 the MAC CE index may indicate to the UE to first switch to TCI state L 306 and to then switch to TCI state M 312 and explicitly indicate the time duration for how long to use each of the TCI states. The MAC CE index may indicate to use TCI state L 306 for a first time duration 320 during the second slot 304 and the third slot 308. The MAC CE index may indicate to use TCI state M 312 for a second time duration 322 during the fourth slot 310.

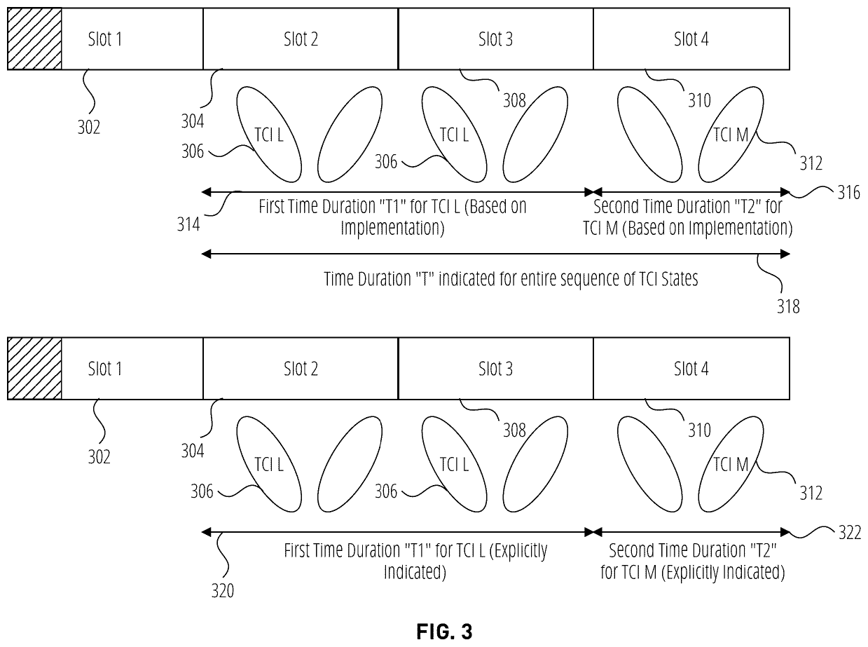

FIG. 4 illustrates an example of separate TCIs with a unified TCI framework, according to embodiments herein. In some embodiments, when a UE supports unified TCI framework with separate configured UL/DL TCI states, the MAC CE may activate two sets of TCI corresponding to an index and additionally at least one time resource associated with the two sets of TCI.

For example, a first set of TCI within an index may correspond to DL TCI states such as DL TCI state L 404 and DL TCI state M 412 for use in DL slots such as the first DL slot 402 and the second DL slot 410, and a second set of TCI within an index corresponds to UL TCI states such as UL TCI state A 408 for use in UL slots such as the UL slot 406. In some instances, the time duration associated with the index may be the duration per TCI state (applicable for both DL TCI states and UL TCI states such as the first time duration 414 for DL, the second time duration 416 for UL, and the third time duration 418 for DL). In some such instances, during the second time duration 416 for UL, if another TCI state for DL is indicated, it may be skipped 420 since the second time duration 416 does not include any DL slots and only includes a UL slot 406.

In some other instances, a total time duration is configured for the index within which a sequence of DL and UL TCI states are accommodated. In such instances, the exact time duration per TCI state may be up to UE implementation.

In one example, at least two time duration values may be included within an index, wherein the first time duration value may be associated with the first set of TCI states and the second duration value is associated with the second set of TCI states within an index. In a second example, multiple time resources may be associated with each of the MAC CE indices, wherein one-to-one mapping between a time resource and the corresponding TCI state within the index is applied for each set of DL and UL TCI states. In a third example, one-to-one mapping between time duration may be applied for one set of TCI states, while a single time duration is associated for the second set of TCI states. For example, for DL TCI states, one-to-one mapping may be applied (e.g., same number of TCI states and corresponding time resources are and for UL TCI states, a single time resource is associated; or vice-versa). It should be understood that the examples discussed herein may be used in various combinations of each other.

In some embodiments, when a UE supports unified TCI framework with joint configured states for both DL and UL, the MAC CE may activate a single set of TCI corresponding to an index and additionally at least one time duration may be associated with the single set of TCI. The time duration is, in some cases, a duration per TCI state. Any UL or DL scheduled during that time duration applies to a corresponding TCI state. If no UL or DL is scheduled during that time duration, then the UE may TCI switch correspondingly to the next duration.

In some other cases, the time duration may be the total time duration within which a sequence of joint TCI states are accommodated. The exact duration per TCI state may be up to UE implementation. In yet some other cases, two durations may be included within an index, where the first duration is associated for DL, while the second duration is associated with UL. Although a joint TCI may be applicable for DL and UL, depending upon the two separate durations, the same or a different joint TCI from the list may be applied for DL and UL.

In some embodiments, for multi-TRP operation, a MAC CE may activate the UE with two sets of TCI states per index, where the first set of TCI states is associated with the first TRP and the second set of TCI states is associated with the second TRP, and additionally, at least one time duration is included per index. The time duration, in some cases may be the duration per TCI state. Any UL or DL scheduled during that time duration applies a corresponding TCI state corresponding to each of the TRPs.

In some other cases, the time duration may be the total time duration within with sequence of TCI states per TRP are accommodated. For example, if a time duration “M” is applied, then all the TCI states for first TRP should be accommodated within the time duration “M” and all the TCI states for the second TRP should be accommodated within the time duration “M”, where the corresponding sequence of TCI states and duration for two TRPs may or may not be overlapping. The duration per TCI state may be up to UE implementation.

In yet some other cases, the time duration may be two durations where the two durations are included within an index. The first duration may be associated with the first TRP, while the second duration may be associated with the second TRP. In some examples, the time duration being a duration per TCI state, as discussed herein, is applied at the TRP level (using corresponding duration associated with each TRP). In some other examples, the time duration being a total time duration within which the sequence of TCI states per TRP are accommodated as discussed herein is applied at TRP level.

Embodiments for an enhanced TCI for multi-TRP discussed herein may be applicable for both joint UL/DL TCI as well as separate UL/DL TCI.

In some embodiments, the UE may report one TCI state or a sequence of TCI states from the activated list of TCI to the network, as part of uplink control information. Additionally, in some examples, the UE may report a time offset to indicate when the indicated TCI state or sequence of TCI states is applied corresponding to the slot on which the uplink control information (UCI) reporting is sent, and a duration for which the one or more of the indicated TCI states are applicable.

In some other embodiments, the UE may report one channel state information reference signal resource indicator (CRI) or a sequence of CRIs from the list of configured CRIs to the network, as part of uplink control information. Additionally, the UE may report a time offset to indicate when the indicated CRI or sequence of CRI is applied corresponding to the slot on which the UCI reporting is sent, and a duration for which the one or more of the indicated CRIs are applicable. In some cases, such reporting of the TCI and/or the CRI may be applicable when the UE is capable of a UE-sided beam prediction.

Note that, in some instances, both the TCI state or sequence of TCI states and the CRI or sequence of CRIs may be reported together.

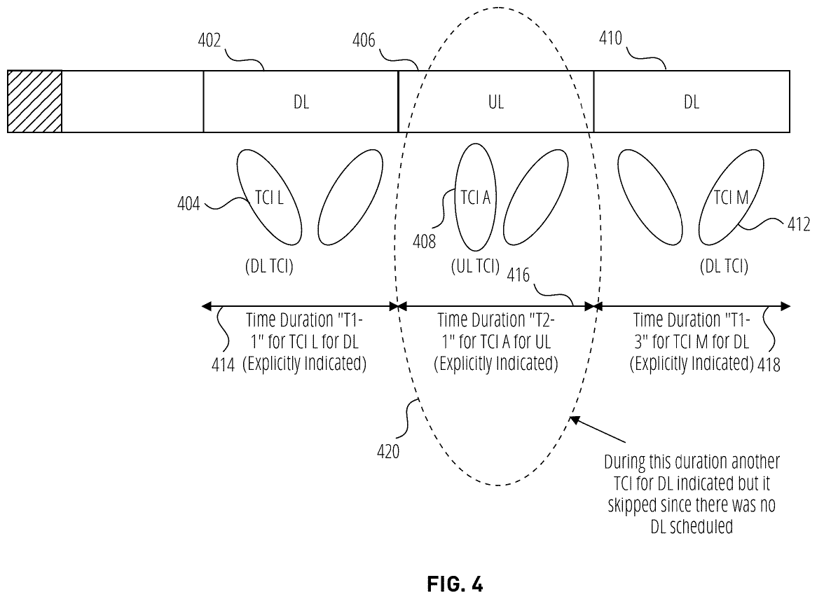

FIG. 5 illustrates a method 500 for a UE, according to embodiments herein. The illustrated method 500 includes receiving 502, from a base station, a configuration message indicating one or more TCI states and one or more time durations corresponding to the one or more TCI states. The method 500 further includes progressively switching 504 between the one or more TCI states, wherein the one or more time durations indicate an amount of time for the UE to remain in the one or more TCI states. The method 500 further includes performing 506, beamforming according to a current TCI state as switching between the one more TCI states occurs.

In some embodiments of the method 500, the one or more TCI states are joint TCI states for UL and DL transmission.

In some embodiments of the method 500, the one or more TCI states are separate TCI states for UL and DL transmission.

In some embodiments of the method 500, the configuration message comprises at least an index value that indicates the one or more TCI states and the one or more time durations.

In some embodiments of the method 500, the one or more TCI states are predicted using an AI/ML model.

In some embodiments of the method 500, the one or more time durations are per the one or more TCI states.

In some embodiments of the method 500, the one or more time durations comprise a total time duration for all of the one or more TCI states.

In some embodiments of the method 500, each of the one or more TCI states comprise a first time duration and a second time duration, and wherein the first time duration comprises a DL time duration and the second time duration comprises an UL time duration.

In some embodiments, the method 500 further comprises transmitting, to the base station, one TCI state of the one or more TCI states or a sequence of the one or more TCI states, transmitting, to the base station, a time offset indicating when the one TCI state or the sequence of the one or more TCI states is applied, and transmitting, to the base station, a duration for when the one TCI state or the sequence of the one or more TCI states is applicable.

In some embodiments, the method 500 further comprises transmitting, to the base station, a single CRI or a sequence of CRIs used for the beamforming from a list of configured CRIs on which the UE performs beam measurements, transmitting, to the base station, a time offset indicating when the one CRI or the sequence of CRIs is applied, and transmitting, to the base station, a duration for when the one CRI or the sequence of CRIs is applicable.

In some embodiments of the method 500, the configuration message comprises a MAC CE, and wherein the MAC CE activates a set of indices comprising the one or more TCI states and the one or more time durations. In some such embodiments, the configuration message further comprises DCI, and wherein the DCI indicates a single index from the set of indices.

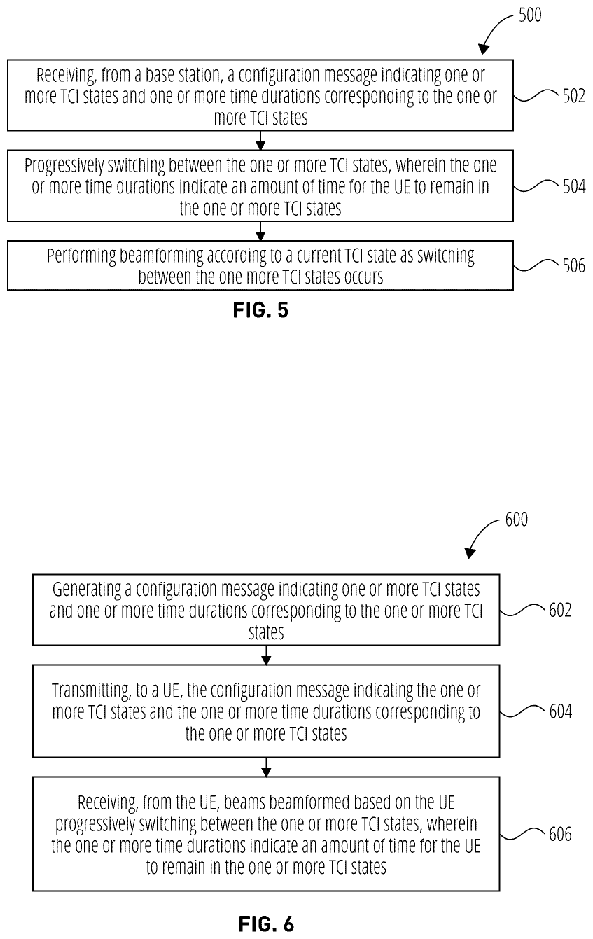

FIG. 6 illustrates a method 600 for a base station, according to embodiments herein. The illustrated method 600 includes generating 602 a configuration message indicating one or more TCI states and one or more time durations corresponding to the one or more TCI states. The method 600 further includes transmitting 604, to a UE, the configuration message indicating the one or more TCI states and the one or more time durations corresponding to the one or more TCI states. The method 600 further includes receiving 606, from the UE, beams beamformed based on the UE progressively switching between the one or more TCI states, wherein the one or more time durations indicate an amount of time for the UE to remain in the one or more TCI states.

In some embodiments of the method 600, the one or more TCI states are joint TCI states for UL and DL transmission, and wherein the configuration message comprises an index value that indicates the one or more TCI states and the one or more time durations.

In some embodiments of the method 600, the one or more TCI states are predicted using an AI/ML model.

In some embodiments of the method 600, the one or more time durations are per the one or more TCI states.

In some embodiments of the method 600, the one or more time durations comprise a total time duration for all of the one or more TCI states.

In some embodiments of the method 600, each of the one or more TCI states comprise a first time duration and a second time duration, and wherein the first time duration comprises a DL time duration and the second time duration comprises an UL time duration.

In some embodiments, the method 600 further comprises receiving, from the UE, one TCI state of the one or more TCI states or a sequence of the one or more TCI states, receiving, from the UE, a time offset indicating when the one TCI state or the sequence of the one or more TCI states is applied, and receiving, from the UE, a duration for when the one TCI state or the sequence of the one or more TCI states is applicable.

In some embodiments, the method 600 further comprises receiving, from the UE, a UCI report comprising a single CRI or a sequence of CRIs used for the beamforming from a list of configured CRIs, receiving, from the UE, a time offset indicating when the one CRI or the sequence of CRIs is applied, and receiving, from the UE, a duration for when the one CRI or the sequence of CRIs is applicable.

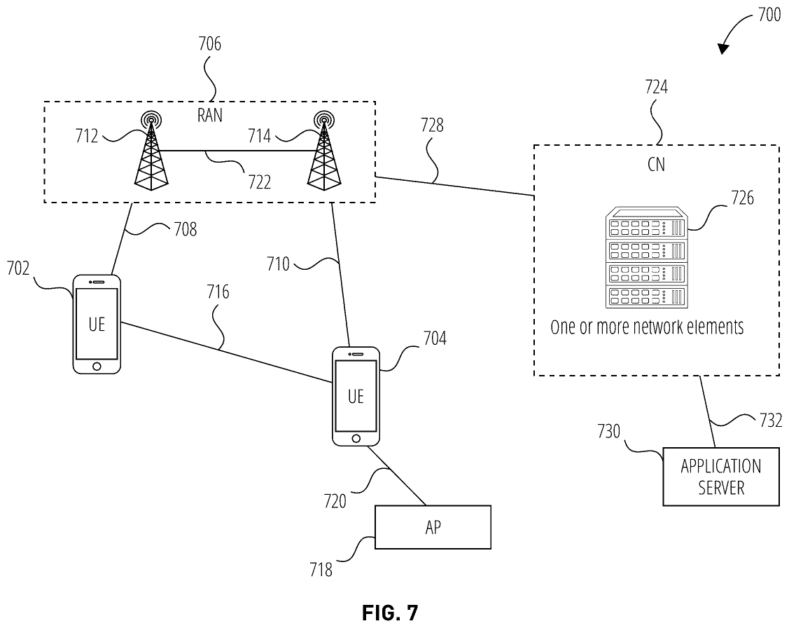

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as base station 712 and base station 714) that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

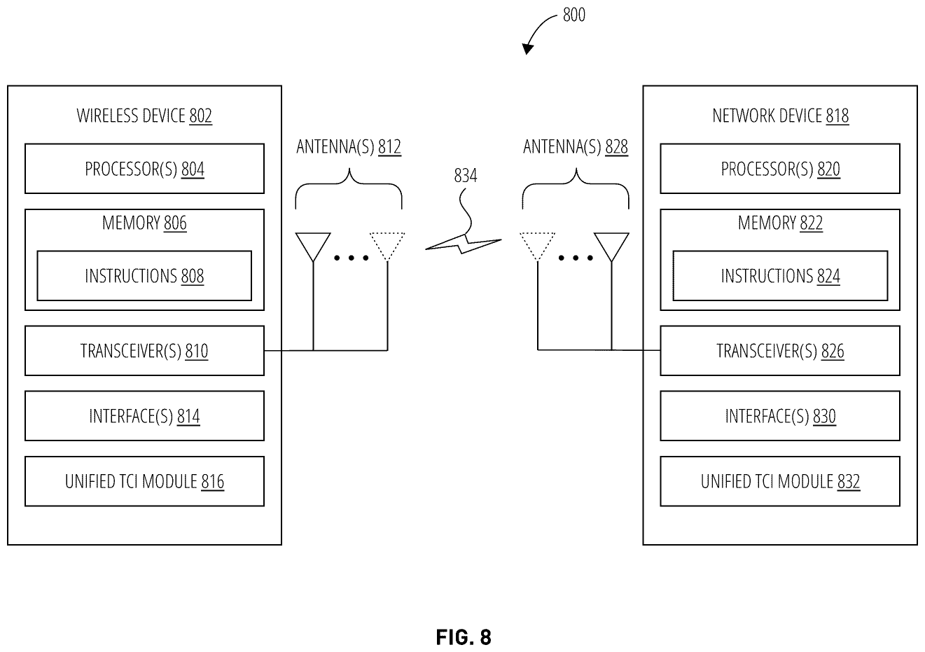

FIG. 8 illustrates a system 800 for performing signaling 834 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter circuitry and/or receiver circuitry that use the antenna(s) 812 of the wireless device 802 to facilitate signaling (e.g., the signaling 834) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth® and the like).

The wireless device 802 may include a unified TCI module 816. The unified TCI module 816 may be implemented via hardware, software, or combinations thereof. For example, the unified TCI module 816 may be implemented as a processor, circuit, and/or instructions 808 stored in the memory 806 and executed by the processor(s) 804. In some examples, the unified TCI module 816 may be integrated within the processor(s) 804 and/or the transceiver(s) 810. For example, the unified TCI module 816 may be implemented by a combination of software components (e.g., executed by a DSP or a general processor) and hardware components (e.g., logic gates and circuitry) within the processor(s) 804 or the transceiver(s) 810.

The unified TCI module 816 may be used for various aspects of the present disclosure, for example, aspects of FIG. 1A through FIG. 6. The unified TCI module 816 may be configured to cause the wireless device 802 to receive, from a network device 818, a configuration message indicating one or more TCI states and one or more time durations corresponding to the one or more TCI states. The unified TCI module 816 may be further configured to cause the wireless device 802 to progressively switch between the one or more TCI states, wherein the one or more time durations indicate an amount of time for the wireless device 802 to remain in the one or more TCI states. The unified TCI module 816 may be further configured to cause the wireless device 802 to perform beamforming according to a current TCI state as switching between the one more TCI states occurs.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter circuitry and/or receiver circuitry that use the antenna(s) 828 of the network device 818 to facilitate signaling (e.g., the signaling 834) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 818 may include a unified TCI module 832. The unified TCI module 832 may be implemented via hardware, software, or combinations thereof. For example, the unified TCI module 832 may be implemented as a processor, circuit, and/or instructions 824 stored in the memory 822 and executed by the processor(s) 820. In some examples, the unified TCI module 832 may be integrated within the processor(s) 820 and/or the transceiver(s) 826. For example, the unified TCI module 832 may be implemented by a combination of software components (e.g., executed by a DSP or a general processor) and hardware components (e.g., logic gates and circuitry) within the processor(s) 820 or the transceiver(s) 826.

The unified TCI module 832 may be used for various aspects of the present disclosure, for example, aspects of FIG. 1A through FIG. 6. The unified TCI module 832 may be configured to cause the network device 818 to generate a configuration message indicating one or more TCI states and one or more time durations corresponding to the one or more TCI states. The unified TCI module 832 may be further configured to cause the network device 818 to transmit, to a wireless device 802, the configuration message indicating the one or more TCI states and the one or more time durations corresponding to the one or more TCI states. The unified TCI module 832 may be further configured to cause the network device 818 to receive, from the wireless device 802, beams beamformed based on the wireless device 802 progressively switching between the one or more TCI states, wherein the one or more time durations indicate an amount of time for the UE to remain in the one or more TCI states.

Embodiments contemplated herein include an apparatus comprising means to perform one or more elements of the method 500. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the method 500. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 802 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

Embodiments contemplated herein include an apparatus comprising means to perform one or more elements of the method 600. This apparatus may be, for example, an apparatus of a base station (such as a network device 818 that is a base station, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a base station (such as a memory 822 of a network device 818 that is a base station, as described herein).

Embodiments contemplated herein include an apparatus comprising logic, modules, or circuitry to perform one or more elements of the method 600. This apparatus may be, for example, an apparatus of a base station (such as a network device 818 that is a base station, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a base station (such as a network device 818 that is a base station, as described herein).

Embodiments contemplated herein include a signal as described in or related to one or more elements of the method 600.

Embodiments contemplated herein include a computer program or computer program product comprising instructions, wherein execution of the program by a processing element is to cause the processing element to carry out one or more elements of the method 600. The processor may be a processor of a base station (such as a processor(s) 820 of a network device 818 that is a base station, as described herein). These instructions may be, for example, located in the processor and/or on a memory of the base station (such as a memory 822 of a network device 818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
receiving, from a base station, a configuration message indicating one or more transmission configuration indicator (TCI) states and one or more time durations corresponding to the one or more TCI states;
progressively switching between the one or more TCI states, wherein the one or more time durations indicate an amount of time for the UE to remain in the one or more TCI states; and
performing beamforming according to a current TCI state as switching between the one more TCI states occurs.

2. The method of claim 1, wherein the one or more TCI states are joint TCI states for uplink (UL) and downlink (DL) transmission.

3. The method of claim 1, wherein the one or more TCI states are separate TCI states for uplink (UL) and downlink (DL) transmission.

4. The method of claim 1, wherein the configuration message comprises at least an index value that indicates the one or more TCI states and the one or more time durations.

5. The method of claim 1, wherein the one or more TCI states are predicted using an artificial intelligence/machine learning (AI/ML) model.

6. The method of claim 1, wherein the one or more time durations are per the one or more TCI states.

7. The method of claim 1, wherein the one or more time durations comprise a total time duration for all of the one or more TCI states.

8. The method of claim 1, wherein each of the one or more TCI states comprise a first time duration and a second time duration, and wherein the first time duration comprises a downlink (DL) time duration and the second time duration comprises an uplink (UL) time duration.

9. The method of claim 1 further comprising:
transmitting, to the base station, one TCI state of the one or more TCI states or a sequence of the one or more TCI states;
transmitting, to the base station, a time offset indicating when the one TCI state or the sequence of the one or more TCI states is applied; and
transmitting, to the base station, a duration for when the one TCI state or the sequence of the one or more TCI states is applicable.

10. The method of claim 1 further comprising:
transmitting, to the base station, a single channel state information reference signal resource indicator (CRI) or a sequence of CRIs used for the beamforming from a list of configured CRIs on which the UE performs beam measurements;
transmitting, to the base station, a time offset indicating when the one CRI or the sequence of CRIs is applied; and
transmitting, to the base station, a duration for when the one CRI or the sequence of CRIs is applicable.

11. The method of claim 1, wherein the configuration message comprises a medium access control control element (MAC CE), and wherein the MAC CE activates a set of indices comprising the one or more TCI states and the one or more time durations.

12. The method of claim 11, wherein the configuration message further comprises downlink control information (DCI), and wherein the DCI indicates a single index from the set of indices.

13. A method for a base station, the method comprising:
generating a configuration message indicating one or more transmission configuration indicator (TCI) states and one or more time durations corresponding to the one or more TCI states, wherein the one or more time durations indicate an amount of time for a user equipment (UE) to remain in the one or more TCI states;
transmitting, to the UE, the configuration message indicating the one or more TCI states and the one or more time durations corresponding to the one or more TCI states; and
receiving, from the UE, a signal beamformed based on the UE progressively switching between the one or more TCI states.

14. The method of claim 13, wherein the one or more TCI states are joint TCI states for uplink (UL) and downlink (DL) transmission, and wherein the configuration message comprises an index value that indicates the one or more TCI states and the one or more time durations.

15. The method of claim 13, wherein the one or more TCI states are predicted using an artificial intelligence/machine learning (AI/ML) model.

16. The method of claim 13, wherein the one or more time durations are per the one or more TCI states or a total time duration for all of the one or more TCI states.

17. The method of claim 13, wherein each of the one or more TCI states comprise a first time duration and a second time duration, and wherein the first time duration comprises a downlink (DL) time duration and the second time duration comprises an uplink (UL) time duration.

18. The method of claim 13, further comprising:
receiving, from the UE, one TCI state of the one or more TCI states or a sequence of the one or more TCI states;
receiving, from the UE, a time offset indicating when the one TCI state or the sequence of the one or more TCI states is applied; and
receiving, from the UE, a duration for when the one TCI state or the sequence of the one or more TCI states is applicable.

19. The method of claim 13, further comprising:
receiving, from the UE, an uplink control information (UCI) report comprising a single channel state information reference signal resource indicator (CRI) or a sequence of CRIs used for the beamforming from a list of configured CRIs;
receiving, from the UE, a time offset indicating when the one CRI or the sequence of CRIs is applied; and
receiving, from the UE, a duration for when the one CRI or the sequence of CRIs is applicable.

20. An apparatus of a user equipment (UE), the apparatus comprising:
a memory configured to store a configuration message; and
one or more processors configured to:
receive, from a base station, the configuration message indicating one or more TCI states and one or more time durations corresponding to the one or more TCI states;
progressively switch between the one or more TCI states, wherein the one or more time durations indicate an amount of time for the UE to remain in the one or more TCI states; and
perform beamforming according to a current TCI state as switching between the one more TCI states occurs.
